(19) United States
(12) Patent Application Publication
(10) Pub. No.: US 2010/0070866 A1
(43) Pub. Date: Mar. 18, 2010

(54) METHOD AND SYSTEM FOR TREATING PRESENCE

(75) Inventors: HSING FU TUNG, TAIPEI CITY (TW); CHE SHIUN HO, TAIPEI CITY (TW); SHIH HAO LIU, KAOHSIUNG CITY (TW); WAN WAN SHEN, TAOYUAN COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, HSINCHU (TW)

(21) Appl. No.: 12/404,884

(22) Filed: Mar. 16, 2009

(30) Foreign Application Priority Data
Sep. 17, 2008 (TW) 097135565

(51) Int. Cl. G06F 3/048

(52) U.S. Cl. 715/733

(57) ABSTRACT

A method for treating presences is performed as follows. A watcher uses “subscribe” in requesting to subscribe presences of contact persons, and the updated presences of the contact persons are transmitted by “notify” to the watchers through a filtering scheme. The filtering scheme is based on GUI display of the watchers, the last accessing time of the contact persons, and/or the auto leave status of the watcher.

### BACKGROUND OF THE INVENTION

(A) Field of the Invention

The present invention is related to a method and a system for presence user agent, and more specifically, to a method and a system for treating presence.

(B) Description of the Related Art

With the rapid development of network communication, communication status service using wireless communication technology is currently a focus of technological development.

Early presence service systems only indicated whether the user was logged in, i.e., the status of the user is either on-line or off-line. Later, advanced statuses such as activity, mood and personal text message were added, and the geographical positions of the users were indicated. Although having many presences increases the user's convenience, network resource requirements are correspondingly increased. For example, with geographical positions of an instant presence, a high frequency of status changes will require a large amount of network bandwidth.

Although wireless technology is advancing rapidly, the bandwidth still cannot meet the demand. The use of wireless communication is limited by functions of the hardware of wireless communication equipment such as computation ability, image display size or battery power capacity. Therefore, if the instant presence system is implemented to wireless communication, the network or equipment may not be able to support the incurred bandwidth loading.

As the presence service increases in popularity, a user may have a contact list including many contact persons. In practice, a large amount of the contact persons may have only used instant message delivery or network voice/video communication when they joined the contact list, and thereafter have seldom communicated. Thus, only a few contact persons are cared about their presence, and need to have their presences updated with regularity.

In view of the foregoing, there is a demand to decrease the number of network messages used by the presence system, so as to decrease the demand of network resources and the computational loading of the communication equipment.

### SUMMARY OF THE INVENTION

In accordance with an aspect of the present invention, a method for treating presences is performed as follows. A watcher uses a “subscribe” function to request to subscribe presences of contact persons, and the presences of the contact persons are transmitted by subsequent “notify” function to the watcher through a filtering scheme. The filtering scheme is based on the graphic user interface (GUI) display of the watcher, non-communication periods of the contact persons and/or the auto leave status of the watcher.

In accordance with another aspect of the present invention, a presence treating system includes a GUI display of a watcher, a presence server and a list server storing a contact list of the watcher. The each updated presences of the contact persons are transmitted by a “notify” function to the watchers' GUI through a filtering scheme. The filtering scheme is based on the GUI display of the watcher, non-communication periods of the contact persons and/or the auto leave status of the watcher.

### BRIEF DESCRIPTION OF THE DRAWINGS

FIG. 1 shows a presence service system in accordance with the present invention;

FIG. 2 shows “subscribe” and “notify” functions of the present invention;

FIG. 3 shows the retrieval of a contact list;

FIG. 4 shows a notify filtering scheme in accordance with an embodiment of the present invention;

FIG. 5 shows an initialization stage of the presence service system in accordance with an embodiment of the present invention; and

FIG. 6 shows a steady stage of the presence service system in accordance with an embodiment of the present invention.

### DETAILED DESCRIPTION OF THE INVENTION

The present invention will be explained with the appended drawings to clearly disclose the technical characteristics of the invention.

Using the presence service system, the user can obtain the statuses of other users after logging into the system. The statuses include the basic “on-line” or “off-line,” the advanced “activity in progress such as meeting or meal,” “user's current mood state” and “geographical location information.” According to the system, each user acts as a presentity and a watcher.

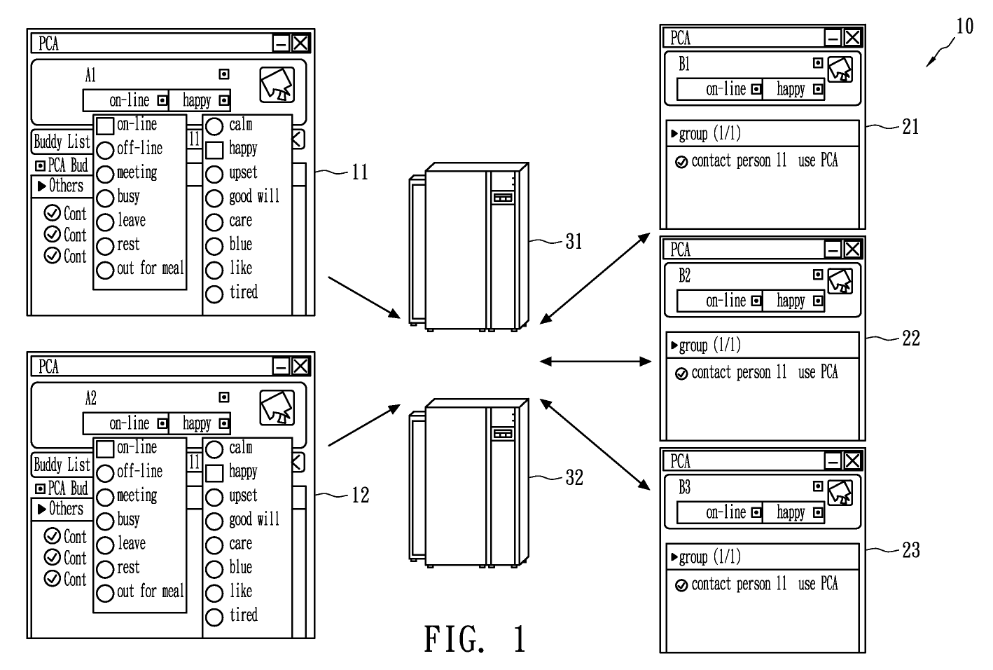

FIG. 1 shows a presence service system 10, which uses a client-server model. The client side includes presentities 11 and 12 and watchers 21, 22 and 23. The presence user agent module of the presence service software manages the communication between the client side and the server side. The server side includes a presence server 31 and a list server 32. The former provides the watchers 21, 22 and/or 23 with presences of the presentities 11 and 12, and the latter stores the contact list of the watchers 21, 22 and/or 23.

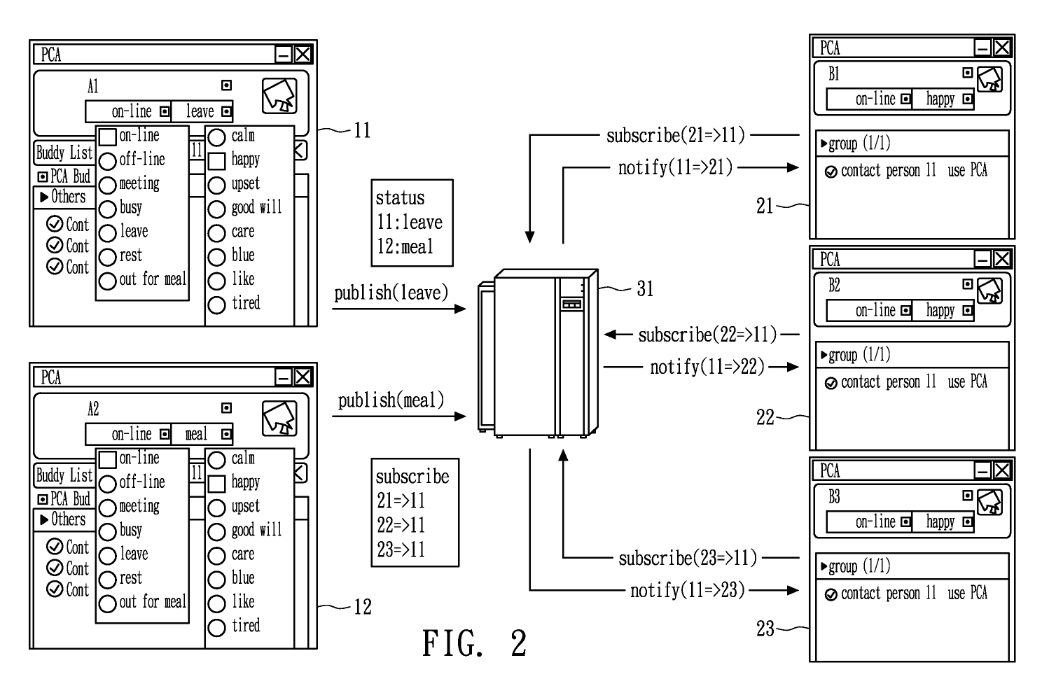

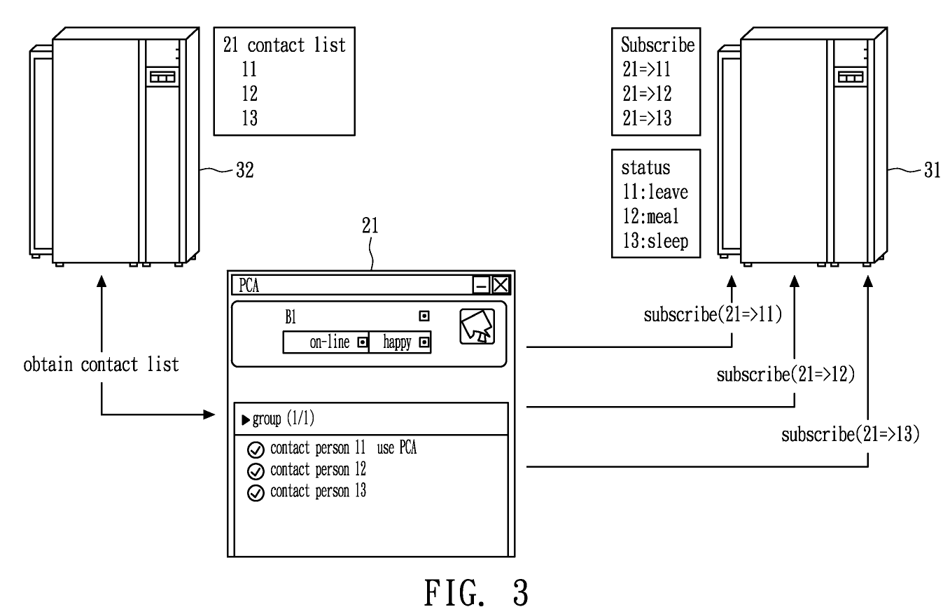

Referring to FIGS. 2 and 3, in accordance with the above architecture, the communication of the presences uses the following mechanisms:

(1) Publish: The presentity 11 and/or 12 transmits its presence to the presence server 31 through this mechanism. The presence server 31 temporarily stores the presence that can be inquired by the watchers 21, 22 and/or 23.

(2) Subscribe/Notify: Referring to FIG. 2, using the “subscribe” function, the watchers 21, 22 and/or 23 can designate “the presentity to be subscribed” to the presence server 31. The presence server 31 uses the “notify” function to inform the watchers of the presence of the subscribed presentity. The subscribe/notify mechanism has an expire value that indicates the duration of the subscription; the presence server 31 records or maintains the subscription relationships between the watchers 21, 22 and/or 23 and the presentities 11 and/or 12 when the “subscribe” request is received. If the presentities 11 and/or 12 publish new statuses during the duration of subscription, the presence server 31 has to “notify” the watcher of the change.

(3) Contact List: Referring to FIG. 3, as to the watcher 21, the subscribed presentities 21, 22 and/or 23 are the contact persons of the watcher 21. For an ordinary presence service system, many users may have more than one contact person. In order to support the user to log into the presence server 31 from various apparatuses, all the contact persons of the watcher 21 are recorded in a “Contact List” document that is saved in the list server 32.

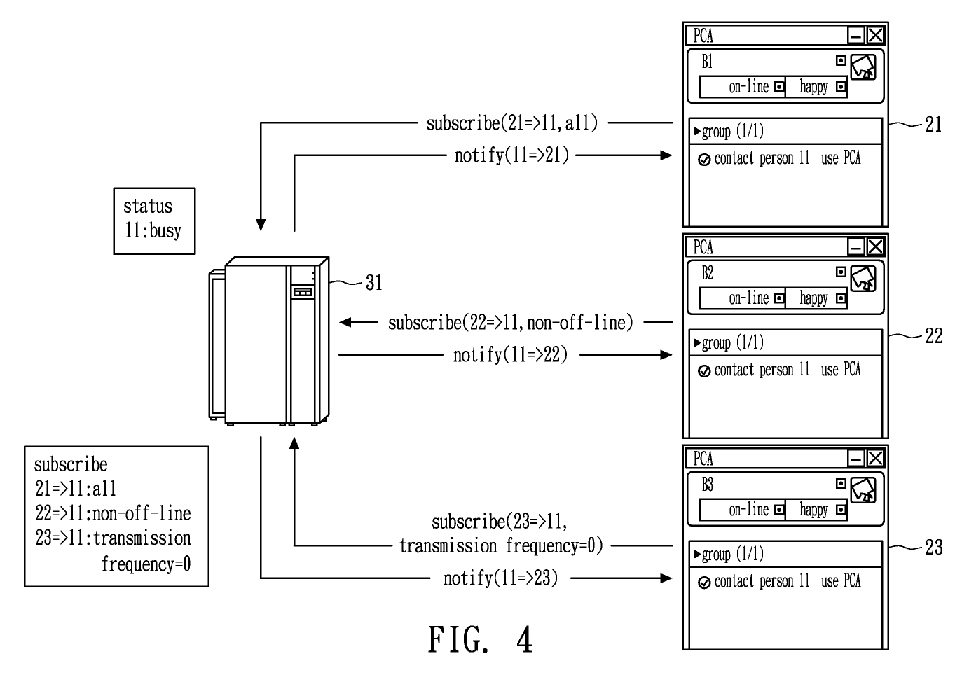

(4) Notify Filtering: Referring to FIG. 4, when the watcher 21, 22 and/or 23 use “subscribe” to establish the subscribe relationships, in addition to designate “the presentity to be subscribed”, the watcher can also designate “notify filtering”. The “notify filtering” includes “trigger conditions” and “transmitting frequency.” The “trigger conditions” requests the presence server 31 to transmit a “notify” request only if the presentities 21, 22 and/or 23 meet specific conditions, and the “transmitting frequency” requests the presence server 31 to transmit “notify” according to a designated frequency. In FIG. 4, according to the filtering conditions of the watchers 21, 22 and/or 23, the “subscribe” of the watcher 21 is set to all conditions, the “subscribe” of the watcher 22 is set to non-off-line, and the transmission frequency is set to zero for the watcher 23. Accordingly, when the presentity 11 changes the status to “meeting,” the watchers 21 and 22 will receive “notify” indicating the change of status. Because the “transmission frequency” is zero for the watcher 23, the watcher 23 will not receive the “notify.” When the presentity 11 changes the status to “off-line,” only the watcher 21 receives the “notify,” and the watcher 22 will not receive the “notify” because the “trigger condition,” i.e., non-off-line, is not met.

Through the above “notify filtering scheme,” the number of “notify” messages can be decreased, thereby decreasing the network flow amount. In practice, the filtering conditions need to be well set to generate the expected efficacy, and in consideration of the user's perspective to reduce the loss of instantaneousness and correctness of the presence. Therefore, the notify filtering of the present invention is based on the extent of watcher desire to the presence of each contact person, considers the decrease of users' manual setting and prevention of generating erroneous presence, and provides a mechanism to assess the necessity of receiving “notify” message.

The assessment of the necessity of receiving “notify” of the present invention considers three assessment factors:

(1) GUI display: according to the actual operation of the watcher, each presentity in the contact list may not be “visible,” i.e., the presence of the contact person may not be shown on the watcher's GUI. In other words, the necessity of receiving “notify” messages depends on whether the contact person in GUI of the watcher is visible. The visibility depends on whether the window of the presence service software at the client side is minimized, the position of the scroll bar of the contact list, expansion or hiding of groups, and the overlap of the presence service software window at the client side and other software windows. If the contact person is visible, the presence information carried by the “notify” message needs to be received, or only the on-line notice of the contact person is received.

(2) The no communication period of the contact persons: One of the main utilizations of the presence service is to determine whether the contact persons are suitable for further initiating communication such as instant messaging and network voice/video communication. If a contact person does not communicate for a long time, the watcher may decide that there is no need to receive the notice of presence of the contact person, or only needs to receive the on-line notice of the contact person. In other words, a no-communication period, i.e., the interval since the last communication between the user and the contact person, determines the necessity of receiving “notify” messages. The determination of the no-communication period is performed with consideration of receiving or initiating instant messaging communication with the contact person, receiving or initiating network voice/video communication with the contact person, and reviewing the contact person's profile and instant inquiry of presence. The determination should cooperate with the expiration mechanism, so that the most-recent communication of each contact person is recorded. The profiles of the contact persons in the “contact list” document may further include the records of the most-recent communication. In other words, the list server further records the last communication time with the contact persons to calculate the no-communication period.

(3) Auto Leave: The presence service may automatically change the status to “Leave” or the like when the user does not do anything for a while. Under such circumstance, the user does not need to receive the notice of presence of the contact person, or only needs to receive the on-line notice of the contact person.

According to the above three factors, the contact persons in the contact list are assessed and categorized into three levels. The corresponding notify filtering conditions for each level are given below.

High Level: The subscription to the contact person is performed according to ordinary subscribe/notify conditions without any filtering conditions. If the contact person changes the status, the user will receive a “notify” message.

Medium Level: Only the “on-line” notice of the contact persons is desired, i.e., using the “trigger condition” mechanism of the notify filtering, and setting to receive the “notify” only if the contact persons change status from off-line to on-line.

Low Level: No presence notice of the contact persons is desired, e.g., the “transmission frequency” mechanism of the notify filtering is set to zero.

Regarding the relation of “factor assessment” and “filtering levels,” the presence service system can establish different corresponding relations depending on the requirement. An embodiment is shown in Table 1. If the watcher does not have the status of “auto leave,” the GUI display of the presence service software of the watcher at the client side is visible and the no communication period between the contact person and the watcher is expired, the filtering level is “medium” according to the relation of “factor assessment” and “filtering levels” of Table 1. Therefore, the watcher only needs to receive the “on-line notice” of the contact person.

TABLE 1
relation of Factor assessment and filtering level

| | | No | No |
|---|---|---|---|
| | | communication | communication |
| | | period with the | period with the |
| | | contact person | contact person is |
| | | is expired | not expired |
| Contact person | Watcher is in | Medium | Medium |
| is visible in | “Auto leave” | | |
| the GUI of | Watcher is in “Not | Medium | High |
| watcher | auto leave” | | |
| Contact person | Watcher is in | Low | Medium |
| is visible in the | “Auto leave” | | |
| GUI of | Watcher is in “Not | Low | Medium |
| watcher | auto leave” | | |

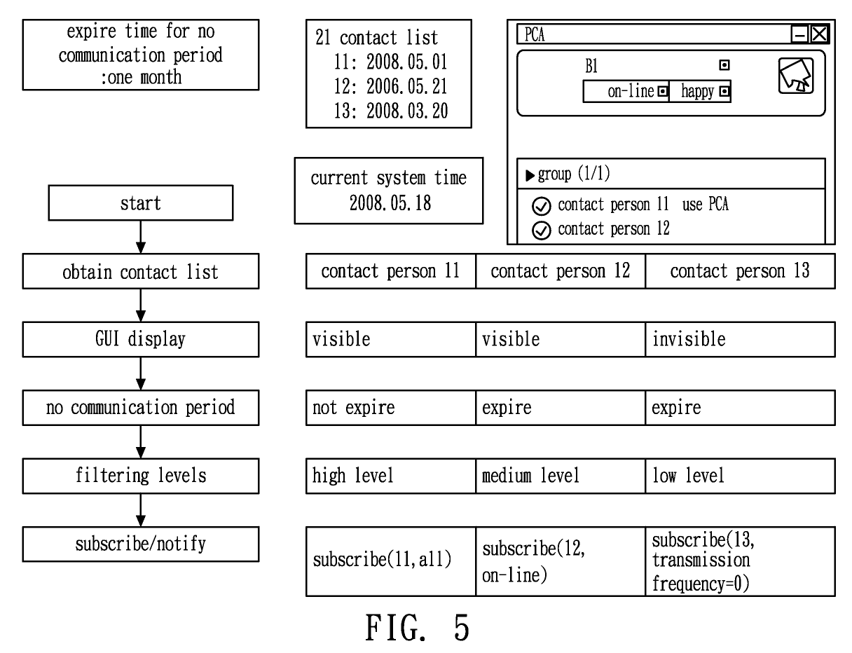

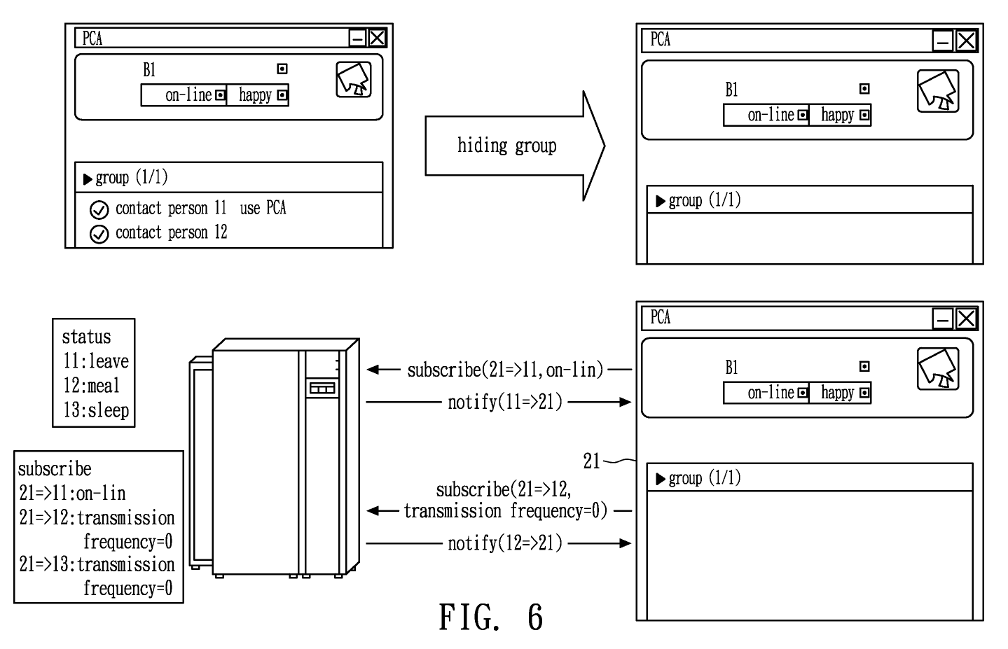

FIG. 5 and FIG. 6 show embodiments with reference to Table 1, showing the behaviors of the user at the initialization stage and steady stage using the presence service system of the present invention.

Initialization stage (refer to FIG. 5):

1. The watcher 21 at the client side retrieves its contact list from the list server 32, and determines filtering levels according to the factor assessment of the contact persons 11, 12 and 13. In the initialization stage, “auto leave” needs not to be considered.

2. GUI display: The upper-right side of FIG. 5 shows the presence service software, in which only the contact persons 11 and 12 are visible.

3. No-communication period of the contact persons: With reference to the contact list of the watcher 21 of FIG. 5, only the no-communication period of the contact person 11 is not expired.

4. Filtering level and subscribe/notify behavior: According to Table 1, the contact person 11 is “high level,” thus there is no need to set any filtering conditions; the contact person 12 is “medium level,” thus the filtering condition is only to receive the “on-line” notice; and the contact person 13 is “low level,” thus no “notify” needs to be received, i.e., the transmission frequency is set to zero.

In brief, at the beginning, the watcher obtains the contact list, and verifies “GUI display” and “no-communication period” to determine “filtering level.” Then, the watcher sends “subscribe” with filtering setting, in which there are no filtering conditions for the contact person 11, the contact person 12 only needs to receive “on-line” notice, and the transmission frequency of the contact person 13 is zero. It is noted that the “GUI display” and “no-communication period” of FIG. 5 are given as examples only, and their performing sequences are not limited.

Steady stage (refer to FIG. 6):

1. The intelligent presence agent module of the presence software monitors the variation of the factors, and adjusts the filtering conditions according to Table 1.

2. In FIG. 6, the watcher 21 hides the group so that the contact persons 11 and 12 become invisible, and therefore the filters level of the contact persons 11 and 12 become “medium level” and “low level,” respectively. A “subscribe” is sent again to adjust the “notify” filtering conditions of the contact persons 11 and 12.

In brief, according to this embodiment, “Auto Leave”, “GUI display” and “no-communication period” are verified, and “subscribe” with filtering setting is sent according to the filtering levels of Table 1.

Moreover, the present invention may include presence service extension module and apparatus (e.g., software) at the client side (e.g., the watcher) for assessing the necessity of changing factors of “notify” and calculating the filtering levels. An extension structure of the contact list document store the time of last access with a contact person so as to verify whether the duration of non-communication is over a threshold.

The mechanism of the present invention clearly assesses the three factors of necessity of receiving “notify,” and the necessity is categorized into three levels, each level having its own filtering rules for “notify.”

The assessment for the three factors is automatically performed by the intelligent presence user agent module of the presence service software, and needs not to be manually set by the user. The three assessment factors are in consideration of the necessity of receiving the notice from the watcher's respect, so that erroneous presence of the contact persons can be effectively decreased.

The mechanism of the present invention is performed by the intelligent presence user agent module added at the client side, and is fully operated at the client side of the presence service system. Therefore, the presence service system can communicate with ordinary presence server and other traditional clients, and no further integration is needed. The mechanism of the present invention has superior compatibility, and therefore can easily penetrate the presence service market.

The above-described embodiments of the present invention are intended to be illustrative only. Numerous alternative embodiments may be devised by those skilled in the art without departing from the scope of the following claims.

What is claimed is:

1. A presence treating method, comprising:
subscribing presences of contact persons by a watcher; and
notifying the watcher of the presences of the contact persons on a basis of a filtering scheme, wherein the filtering scheme is based on at least one of graphic user interface (GUI) display, no-communication period of the contact persons, and auto leave status of the watcher.

2. The presence treating method of claim 1, wherein the filtering scheme assesses a necessity of notifying the watcher.

3. The presence treating method of claim 1, wherein the GUI display indicates whether the contact persons in the watcher's GUI are visible so as to determine a necessity of notifying the watcher.

4. The presence treating method of claim 3, wherein the indication of whether the contact persons in the watcher's GUI are visible depends on whether a presence service software window at a client side is minimized, a position of a scroll bar of a contact list window of the contact persons, an expansion or hiding of a group, and an overlap of presence service software window at a client side and/or other software windows.

5. The presence treating method of claim 1, wherein the no-communication period is an interval since a last communication between the watcher and the contact persons so as to determine a necessity of notifying the watcher.

6. The presence treating method of claim 5, wherein the no-communication period is determined by communication behaviors comprising receiving/initiating instant messaging communication with the contact persons, receiving/initiating network voice/video communication with the contact persons, reviewing the contact person's profile and instant inquiry of presence of the contact person.

7. The presence treating method of claim 1, wherein the auto leave status of the watcher is related to automatically changing the presence of the user to leave status when a presence service software at a client side of the watcher is not used for a determined period of time so as to determine a necessity of notifying the watcher.

8. The presence treating method of claim 1, wherein the filtering scheme comprises a plurality of filtering levels.

9. The presence treating method of claim 8, wherein the plurality of filtering levels comprises:
a high level of no filtering conditions, notifying the watcher whenever the status of the contact person of the high level is changed;
a medium level, notifying the watcher whenever the contact person of the medium level changes from off-line to on-line; and
a low level, the contact person of the low level having a zero transmission frequency of notifying the watcher.

10. The presence treating method of claim 8, wherein the filtering levels are adjusted timely as determined by assessment process of the filtering levels.

11. A presence treating system, comprising:
a graphic user interface (GUI) of a watcher;
a presence server; and
a list server storing a contact list of the watcher;
wherein the watcher is notified of the presences of the contact persons on a basis of a filtering scheme, and the filtering scheme is based on at least one of graphic user interface (GUI) display, no-communication period of the contact persons, and auto leave status of the watcher.

12. The presence treating system of claim 11, wherein the list server further stores a last access time of the contact person to determine the no-communication period.

13. The presence treating system of claim 11, wherein the filtering scheme is performed at the watcher's side.

14. The presence treating system of claim 11, wherein the GUI display indicates whether the contact persons in the GUI of the watcher are visible so as to determine a necessity of notifying the watcher.

15. The presence treating system of claim 14, wherein the indication of whether the contact persons in the watcher's GUI are visible depends on whether a presence service software window at a client side is minimized, a position of a scroll bar of a contact list window of the contact persons, an expansion or hiding of a group, and an overlap of presence service software window at a client side and/or other software windows.

16. The presence treating system of claim 11, wherein the no-communication period is an interval since the last communication between the watcher and the contact persons so as to determine a necessity of notifying the watcher.

17. The presence treating system of claim 16, wherein the non-communication period is determined by communication behaviors comprising receiving/initiating instant messaging communication with the contact persons, receiving/initiating network voice/video communication with the contact persons, reviewing the contact person's profile and instant inquiry of presence of the contact person.

18. The presence treating system of claim 11, wherein the auto leave status of the watcher is related to automatically changing the presence of the user to leave status when a presence service software at a client side of the watcher is not used for a determined time so as to determine a necessity of notifying the watcher.

19. The presence treating system of claim 11, wherein the filtering scheme comprises a plurality of filtering levels.

20. The presence treating system of claim 19, wherein the plurality of filtering levels comprises:
a high level of no filtering conditions, notifying the watcher whenever the status of the contact person of the high level is changed;
a medium level, notifying the watcher whenever the contact person of the medium level changes from off-line to on-line; and
a low level, the contact person of the low level having a zero transmission frequency of notifying the watcher.

21. The presence treating system of claim 19, wherein the 15 filtering levels are adjusted timely as determined by assessment process of the filtering levels.
